(19) United States
(12) Patent Application Publication
(10) Pub. No.: US 2003/0102796 A1
(43) Pub. Date: Jun. 5, 2003

(54) Cathode ray tube

(76) Inventors: Shuhei Nakata, Tokyo (JP); Tetsuya Siroishi, Tokyo (JP); Katsumi Oono, Tokyo (JP); Fumiaki Murakami, Tokyo (JP)

Correspondence Address: BIRCH STEWART KOLASCH & BIRCH, PO BOX 747, FALLS CHURCH, VA, 22040-0747, US

(21) Appl. No.: 10/239,786

(22) PCT Filed: Nov. 19, 2001
(86) PCT No.: PCT/JP01/10091

(30) Foreign Application Priority Data
Nov. 21, 2000 (JP) 2000-354227
Jan. 30, 2001 (JP) 2001-021349
Mar. 2, 2001 (JP) 2001-058164
Jul. 2, 2001 (JP) 2001-200740

(51) Int. Cl. H01J 29/46; H01J 29/50

(52) U.S. Cl. 313/460; 313/458

(57) ABSTRACT

In a cathode ray tube including a cathode and a first and a second electrodes provided with an electron passing aperture, in which the first and the second electrodes are disposed in front of and coaxially with the cathode so that electron beam from the cathode passes through the electron passing aperture, the cathode voltage at the cutoff operation is set up from 50 V to 80 V on the basis of the first electrode to thereby realize a high luminance.

### TECHNICAL FIELD

The present invention relates to a cathode ray tube for use in an image display CRT or the like, and particularly to an electrode structure at an electron emission section in a cathode ray tube.

### BACKGROUND ART

A common electrode structure at an electron emission section in a cathode ray tube is shown in FIG. 12. FIG. 12 is referenced from “The electron ion beam handbook, ver. 3”, pp. 143, and is a block diagram showing the common electrode structure at an electrode emission section in a cathode ray tube. As shown in the diagram, a structure of a common electron emission section is composed of a cathode 1, a first electrode 2, and a second electrode 3 both provided in front of the cathode 1. The first electrode 2 and the second electrode 3 include a first electrode aperture 5 and a second electrode aperture 6 respectively as electron passage aperture, and are arranged in a coaxial relationship so that electron beam from the cathode 1 might be passed through therein. The cathode 1 and the second electrode 3 are connected to a power source V which supply a predetermined level of the voltage, and the first electrode 2 is a ground potential.

Hereinafter, an adjustment of an image luminance on a screen (not shown) provided in opposite to the cathode 1 is explained. The image luminance of the cathode ray tube is substantially in proportion to a current value received at the screen. That is, a large amount of current is drawn from the cathode 1 in a high luminance state, and a small amount of current is drawn in a low luminance state. The adjustment (modulation) of the current value drawn from the cathode 1 is carried out by using a cathode voltage. FIG. 13 is a characteristic diagram showing the relation between the cathode modulating voltage and the cathode emission current in a common cathode ray tube, where the horizontal axis represents a voltage supplied from the power source V to the cathode. It is noted that the cathode voltage at which the emission current starts is called a cutoff voltage and the voltage to be applied to the cathode on the basis of the cutoff voltage (0 V) is called a cathode modulating voltage. As shown in FIG. 13, the emission current value from the cathode is reduced by lowering the cathode modulating voltage (in the leftward direction of the horizontal axis in FIG. 13).

In a structure of the conventional cathode ray tube, for example, the aperture diameter of its first electrode and second electrode is 0.35 mm, the thickness of its first electrode is 0.08 mm, the thickness of its second electrode is 0.3 mm, and the distance between its first and second electrodes is 0.25 mm.

Accordingly, in this structure, the aperture diameter of the first electrode, the thickness about the aperture of the first electrode, the aperture diameter of the second electrode, the thickness about the aperture of the second electrode, and the distance between the first and second electrodes are determined so as to satisfy:

the thickness about the aperture of the second electrode/the aperture diameter of the second electrode ≅0.86;

the distance between the first and second electrodes/the aperture diameter of the second electrode≅0.71; and

the thickness about the aperture of the first electrode/the aperture diameter of the first electrode≅0.23.

The cutoff voltage during the operation of the electron gun is approximately 110 V. This structure, however, fails to satisfy the distance between the first and second electrodes/the aperture diameter of the second electrode≦0.69, which is one of the three conditional expressions according to claim 2 of the present invention.

In the conventional structure, the cutoff voltage during the operation is approximately 110 V.

In the conventional cathode ray tube with the above-mentioned structure, the emission current at 50 V of the modulating voltage is approximately 450 μA.

One of the indicators for representing the function of the electron emission section is a numeric value called emittance. The emittance is a numeric value determined by the imaginary object point width and the divergence angle of electrons after passing through the electron emission section. Generally, by comparison at the same emission current value, if the emittance is high, the spot diameter obtained on the screen will be increased, and the resolution will be declined. On the other hand, if the emittance is low, the spot diameter will be decreased, and the resolution is improved. The numeric value of the emittance depicted in the present description is a product value of the divergence angle and the object point width which are calculated when 5% of the electrons path furthest from the central axis in the obtained electrons paths is excluded under a simulated condition at 300 μA of the emission current in a simulation. The reason not to take 5% of the electrons path into consideration is that the 5% electron beam, which is furthest from the central axis, might form an outside of the spot on the screen, but the portion is too dark and to be explicitly perceived, so that it might hardly affect the resolution.

Since the object point width is directly calculated with much difficulty, the value of the emittance is fundamentally determined from a simulation. On the other hand, the divergence angle can be simply calculated from a measurement comparatively, and the measurement is then compared with the simulated measurement. As a result, the divergence angles are substantially identical when the simulated thickness of the second electrode is increased about 10% from the measured thickness and the simulated distance between the first and second electrodes is increased about 30% from the measured distance. The emittance value according to the present description uses a numerical value obtained by the simulation with the thickness of the second electrode and the supplementary distance between the first and second electrodes being corrected to proper values.

In the above-mentioned conventional cathode ray tube, the emittance is approximately 690 μm.mrad, and in the cathode ray tube used for displaying an image as a display monitor, the emittance level has to be lowered.

As explained above, the cathode ray tube used in an image display or the like has its emission current increased by increasing the cathode modulating voltage. However, with the improvement of resolution of the cathode ray tube, the frequency of a video signal to be inputted to the cathode 1 becomes a very high frequency so that it is substantially increased up to limit of function of an amplifier which forms the cathode modulating voltage. Since the maximum of amplified output of the common cathode ray tube used in a display monitor is approximately 50 V, the modulating voltage can hardly be increased to gain the high-luminance particularly in view of the cost.

For solving such problems, the cathode voltage might be decreased at the cutoff operation by lowering the voltage at the second electrode 3. However, the emittance is increased and the diameter of a spot on the screen becomes larger, so that the resolution might be declined due to the focusing deterioration.

The present invention has been made for solving the above-mentioned problems and its object is intended for minimizing the diameter of the electron beam spot, maintaining the resolution, and having a desired level of the luminance at a smaller modulating voltage than that of the prior art. When the modulating voltage is modulated up to approximately 50 V, which is an upper limit of the amplifier output, the high-luminance display, which is hardly achieved by any conventional cathode ray tube for use in a display monitor can be possible.

### DISCLOSURE OF INVENTION

A cathode ray tube according to a first aspect of the present invention includes a cathode and a first and a second electrodes provided with an electron passing aperture, in which the first and the second electrodes are disposed in front of and coaxially with the cathode so that electron beam from the cathode passes through the electron passing aperture, wherein the cathode voltage at the cutoff operation is set up from 50 V to 80 V on the basis of the first electrode. As a result, the cathode ray tube can be improved in the luminance.

A cathode ray tube according to a second aspect of the present invention has a configuration such that the aperture diameter of the first electrode, the thickness about the aperture of the first electrode, the aperture diameter of the second electrode, the thickness about the aperture of the second electrode, and the distance between the first and second electrodes satisfy the following conditional equation:

the thickness about the aperture of the second electrode/the aperture diameter of the second electrode≦0.87;

the distance between the first and second electrodes/the aperture diameter of the second electrode≦0.73;

the thickness about the aperture of the first electrode/the aperture diameter of the first electrode≦0.23; and

the aperture diameter of the second electrode≧0.4 mm. Accordingly, the current can be increased to a level of approximately 1.7 times greater with the modulating voltage remaining unchanged and the resolution can be maintained at a level equal to that of any conventional cathode ray tube.

A cathode ray tube according to a third aspect of the present invention is so constituted that the cathode in the first aspect of the present invention includes a tungsten layer formed on a substrate surface, and an alkaline earth metal oxide containing at least Ba and an alkaline earth metal deposited on the tungsten layer. Accordingly, the cathode ray tube can be improved in the luminance while the efficiency of current emission from the cathode can be increased.

### BRIEF DESCRIPTION OF DRAWINGS

FIG. 1 is a characteristic diagram showing the relation between visibility and luminance of a cathode ray tube according to Embodiment 1 of the present invention;

FIG. 2 is a characteristic diagram showing the relation between luminance and cutoff voltage of the cathode ray tube driven at 50 V according to Embodiment 1 of the present invention;

FIG. 3 is a characteristic diagram showing the relation between current density and radius R(m) of the cathode of the cathode ray tube according to Embodiment 1 of the present invention;

FIG. 4 is a characteristic diagram showing the relation between distribution function and radius R(m) of the cathode of a cathode ray tube according to Embodiment 2 of the present invention;

FIG. 5 is a characteristic diagram showing the relation between cathode modulating voltage and emission voltage of a cathode ray tube according to Embodiment 3 of the present invention;

FIG. 6 is a characteristic diagram showing a change of the emittance in relation to the ratio between the thickness and the aperture diameter of a second electrode in the cathode ray tube according to Embodiment 3 of the present invention;

FIG. 7 is a characteristic diagram showing a change of the emission current in relation to the ratio between the thickness and the aperture diameter of the second electrode in the cathode ray tube according to Embodiment 3 of the present invention;

FIG. 8 is a characteristic diagram showing a change of the emittance in relation to the ratio between the distance between the first and second electrodes and the aperture diameter of the second electrode in the cathode ray tube according to Embodiment 3 of the present invention;

FIG. 9 is a characteristic diagram showing a change of the emission current in relation to the ratio between the distance between the first and second electrodes and the aperture diameter of the second electrode in the cathode ray tube according to Embodiment 1 of the present invention;

FIG. 10 is a characteristic diagram showing a change of the emittance in relation to the ratio between the thickness and the aperture diameter of the first electrode in the cathode ray tube according to Embodiment 3 of the present invention;

FIG. 11 is a characteristic diagram showing a change of the emission current in relation to the ratio between the thickness and the aperture diameter of the first electrode in the cathode ray tube according to Embodiment 3 of the present invention;

FIG. 12 is a schematic diagram showing an electrode construction at an electron emission section of a conventional cathode ray tube; and

FIG. 13 is a characteristic diagram showing the relation between cathode modulating voltage and emission current of the conventional cathode ray tube.

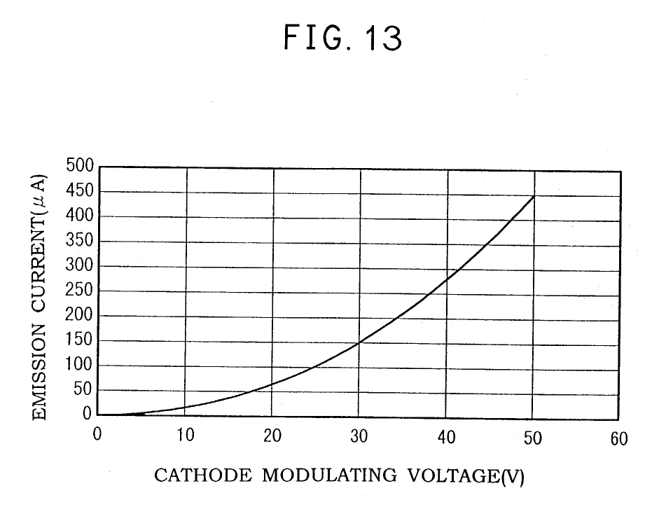

### BEST MODE FOR CARRYING OUT THE INVENTION

Embodiments of the present invention will be described referring to the relevant drawings.

### Embodiment 1

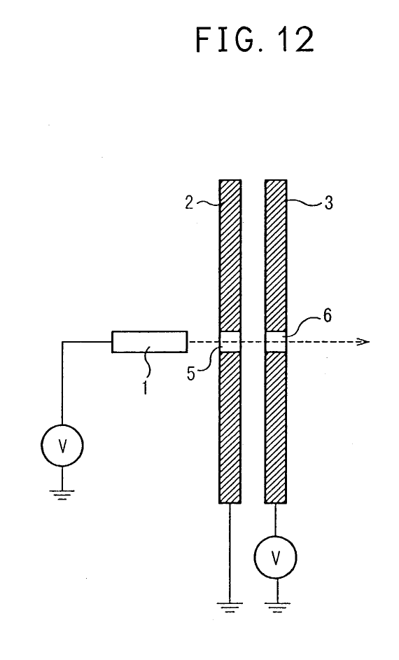

An electrode construction at an electron emission section of Embodiment 1 of the present invention is explained referring to FIG. 12. The electrode construction at an electron emission section of Embodiment 1 is identical to that of the electron emission section of a conventional cathode ray tube described previously with FIG. 12. As shown in FIG. 12, reference numeral 1 denotes a cathode, 2 a first electrode, 3 a second electrode, 5 an aperture provided in the first electrode (for passing of electrons), and 6 an aperture provided in the second electrode (for passing of electrons). The first electrode 2 and the second electrode 3 are located coaxially in front of the cathode 1, so that electrons emitted from the cathode 1 are passed through apertures described above, thus constituting a three-electrode construction of the cathode ray tube. Embodiment 1 are defined in claims 1 and 3.

The electron emission section is so arranged that the aperture diameter of the first electrode is 0.35 mm, the aperture diameter of the second electrode is 0.44 mm, the thickness of the first electrode is 0.065 mm, the thickness of the second electrode is 0.38 mm, and the distance between the first and the second electrode is 0.3 mm. Operating conditions are that the cathode voltage at the cutoff action is 65 V (based on the first electrode) and the voltages applied to the first and second voltage are 0 V and 400 V respectively.

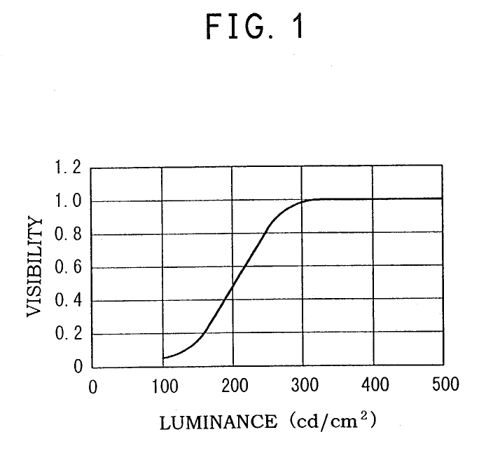

FIG. 1 illustrates the relation between peak luminance and visibility when the cathode ray tube is displayed with a motion or still natural image (for example, in case of displaying an image of digital picture on the cathode ray tube).

As apparent from FIG. 1, the visibility of a motion image is highly enhanced at substantially 300 nit of the luminance, but otherwise remains nearly unchanged (The visibility will further be depicted in “Display”, a monthly magazine, July in 2001). It is known from the relation between the visibility and the luminance that a common CRT monitor of 17-inch screen size is operated with 150 nit of the luminance and not suited for displaying a motion image.

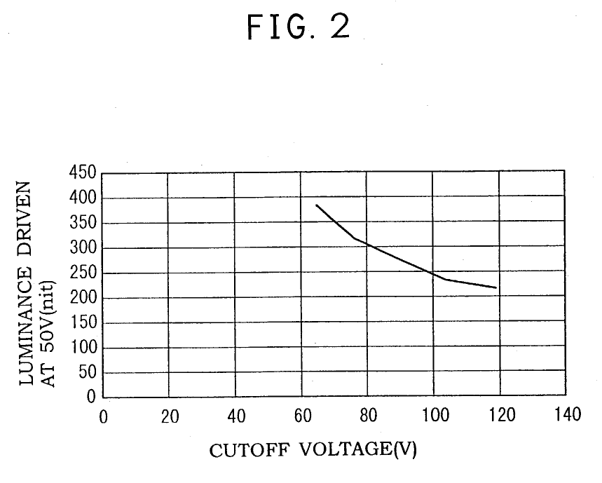

FIG. 2 illustrates the relation between cutoff voltage and peak luminance when energized with 50 V. As apparent from FIG. 2, the cutoff voltage should stay not more than 80 V for maintaining the peak luminance at 300 nit. As defined in claims, the cutoff voltage is limited to a range.

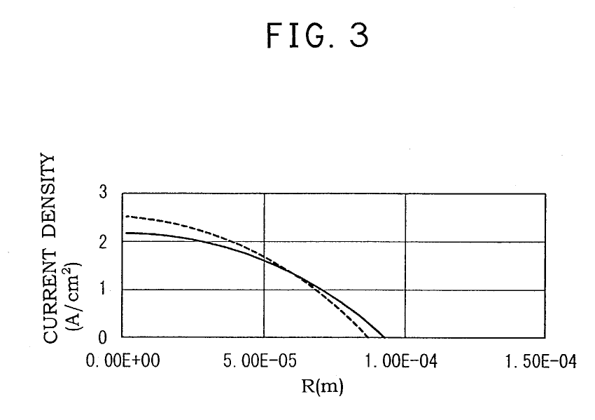

FIG. 3 illustrates a profile of the generated current density on the cathode. The real line represents the current density of Embodiment 1 while the broken line represents that of the prior art. As shown in FIG. 3, it is found that the load is slightly reduced in this embodiment. It is however predicted that the load is sharply increased in order to generate high luminance. Hence, the cathode might preferably be fabricated using a tungsten vapor deposition technique. The tungsten deposited cathode has an electron-emitting source which is provided on a tungsten layer deposited on the substrate and which includes alkaline earth metal oxide containing at least Ba and alkaline earth metals such as Ca or St, and its current can be increased at less cost. The tungsten deposited cathode is also advantageous in the lengthening of operating life as compared with other common cathodes.

### Embodiment 2

The electrode construction at an electron emission section of Embodiment 2 of the present invention will be described referring to FIG. 12. The electrode construction at an electron emission section of Embodiment 2 is identical to that of the electron emission section of a conventional cathode ray tube described previously with FIG. 12. As shown in FIG. 12, reference numeral 1 denotes a cathode, 2 a first electrode, 3 a second electrode, 5 an aperture provided in the first electrode (for passing of electrons), and 6 an aperture provided in the second electrode (for passing of electrons). The first electrode 2 and the second electrode 3 are located coaxially in front of the cathode 1, so that electrons emitted from the cathode 1 are passed through their apertures described above, thus constituting a three-electrode construction of the cathode ray tube. Embodiment 2 is defined in claim 2.

The electron emission section of this embodiment is so arranged that the aperture diameter of the first electrode is 0.30 mm, the aperture diameter of the second electrode is 0.44 mm, the thickness of the first electrode is 0.065 mm, the thickness of the second electrode is 0.38 mm, and the distance between the first and second electrodes is 0.23 mm. Operating conditions are that the cathode voltage at the cutoff action is 50 V (based on the first electrode) and the voltages applied to the first and second voltage are 0 V and 510 V respectively.

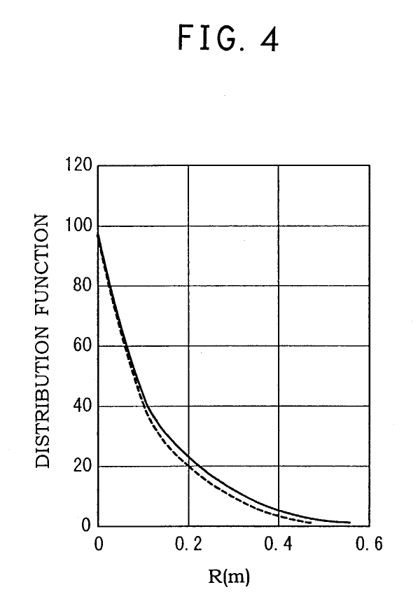

FIG. 4 illustrates a profile of the electron beam of Embodiment 2. More specifically, there is shown the profile of the electron beam on the screen, i.e. the distribution state of the electron beam along a radial direction of the screen when the cutoff voltage of the electron gun is 50 V.

The real line represents the profile of the electron beam of Embodiment 2 while the broken line represents that of the prior art. The cathode ray tube of Embodiment 2 can provide 300 nit of the luminance when energized with 45 V and its electron beam can produce a profile substantially identical to that of any conventional cathode ray tube, as shown in FIG. 4. It is accordingly presumed that the emittance is substantially equal to that of the prior art.

In Embodiment 2, the thickness about the aperture of the first electrode, the aperture diameter of the second electrode, the thickness about the aperture of the second electrode, and the distance between the first and second electrodes are determined so as to satisfy:

the thickness about the aperture of the second electrode/the aperture diameter of the second electrode≅0.86,

the distance between the first and second electrodes/the aperture diameter of the second electrode≅0.68,

the thickness about the aperture of the first electrode/the aperture diameter of the first electrode≅0.18, and

the aperture diameter of the second electrode=0.4 mm.

The construction of this embodiment can hence satisfy the four requirements defined in claim 2.

The electron emission section of Embodiment 2 is so arranged that the aperture diameter of the first electrode is 0.35 mm, the aperture diameter of the second electrode is 0.44 mm, the thickness of the first electrode is 0.065 mm, the thickness of the second electrode is 0.38 mm, and the distance between the first and second electrodes is 0.3 mm. Operating conditions are that the cathode voltage at the cutoff action is 65 V (based on the first electrode) and the voltages applied to the first and second voltage are 0 V and 400 V respectively.

The lower the cutoff voltage is, the greater the emission current will be increased with the modulating voltage remaining unchanged. However, since the modulating voltage at the cathode is 50 and several volts including an adjustable allowance, the cutoff voltage has to be not less than 50 and several volts. When the cathode voltage is declined lower than the voltage at the first electrode, its resultant electrons might enter the first electrode thus shortening the operational life of the cathode.

Moreover, the voltage of the first and second electrodes in a conventional color cathode ray tube is common to the three primary colors; red, green, and blue. This might generate variations of the components and the assembling action, hence creating a modification of the cutoff voltage ranging from a few to tens volts. Accordingly, the cutoff voltage is controllably set to 65 V or practically to a range from 50 V to 80 V.

### Embodiment 3

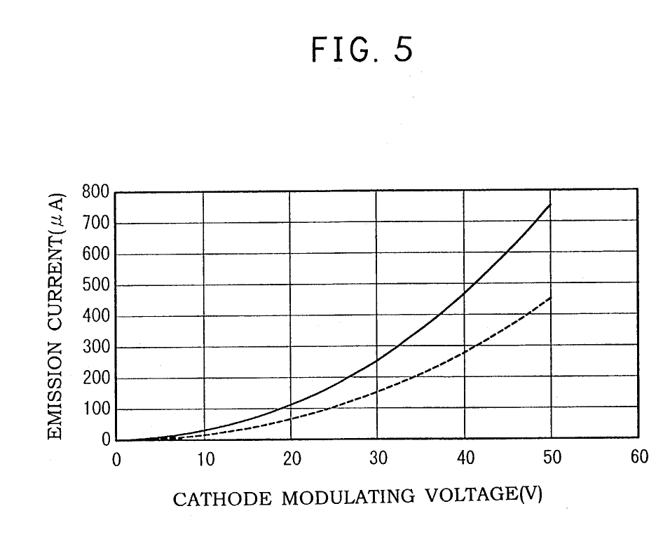

FIG. 5 is a characteristic diagram explaining Embodiment 3 of the present invention. In the diagram, the vertical axis represents the emission current from the cathode and the horizontal axis represents the cathode modulating voltage.

In Embodiment 3, the aperture diameter of the first electrode, the thickness about the aperture of the first electrode, the thickness about the aperture of the second electrode, and the distance between the first and second electrodes are determined so as to satisfy:

the thickness about the aperture of the second electrode/the aperture diameter of the second electrode≅0.86,

the distance between the first and second electrodes/the aperture diameter of the second electrode≅0.68,

the thickness about the aperture of the first electrode/the aperture diameter of the first electrode≅0.23, and

the aperture diameter of the second electrode=0.44 mm.

The construction of this embodiment can marginally satisfy the four requirements defined in claim 2. Embodiment 3 is defined in claim 2.

FIG. 5 illustrates the relation between cathode modulating voltage and emission voltage where the real line represents the current of Embodiment 3 while the broken line represents the current of the prior art. As apparent from FIG. 5, the cathode ray tube of Embodiment 3 allows the emission current to be as high as approximately 750 μA at 50 V of the modulating voltage and more specifically, a level 1.7 times greater than that of the prior art if the modulating voltage remains unchanged.

The emittance in Embodiment 3 is approximately 690 μm.mrad and can hence reproduce an image at the resolution equal to that of the prior art.

Embodiment 3 allows the cutoff voltage to stay within a range from 50 V to 80 V and enables to satisfy the four requirements defined in claim 2. As a result, the emission current can be increased to a 1.7 times greater level without declining the resolution, thus offering the display at a high resolution which has been impossible to realize in the prior art.

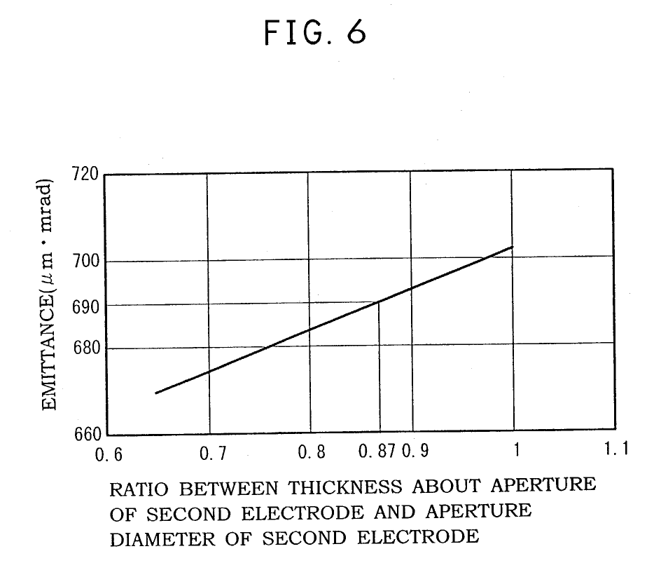

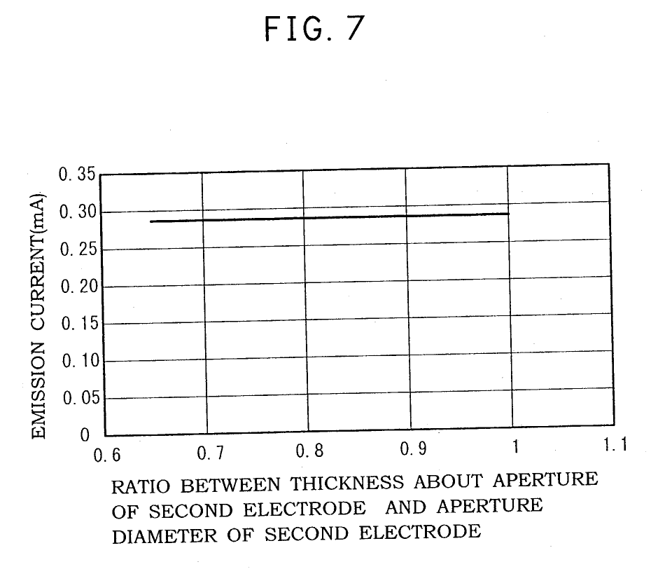

FIG. 6 illustrates the result of a simulation of Embodiment 3 using the thickness about the aperture of the second electrode and the aperture diameter of the second electrode as parameters when the cutoff voltage is 65 V, the voltage at the first electrode is 0 V, and the voltage at the second electrode is 400 V. As apparent from FIG. 6, the thickness about the aperture of the second electrode/the aperture diameter of the second electrode has to be not more than 0.87 for holding the emittance not more than 690 μm.mrad. FIG. 7 illustrates the emission current at 32 V of the cathode modulating voltage using the thickness about the aperture of the second electrode and the aperture diameter of the second electrode as parameters. As apparent from FIG. 7, the emission current will rarely change when the thickness about the aperture of the second electrode/the aperture diameter of the second electrode is changed.

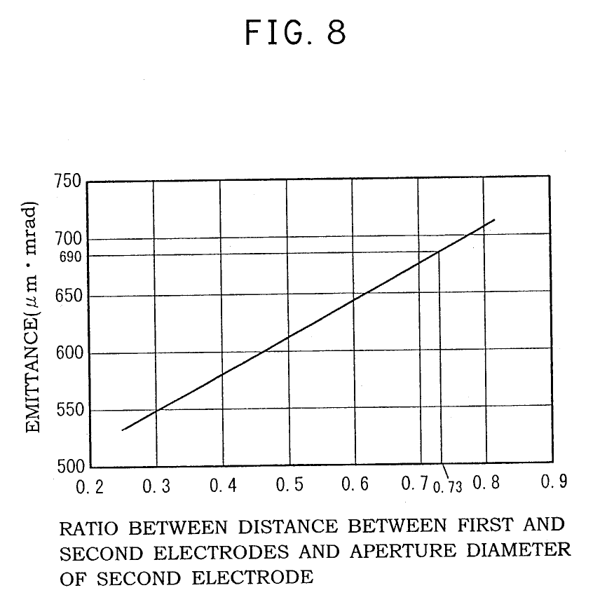

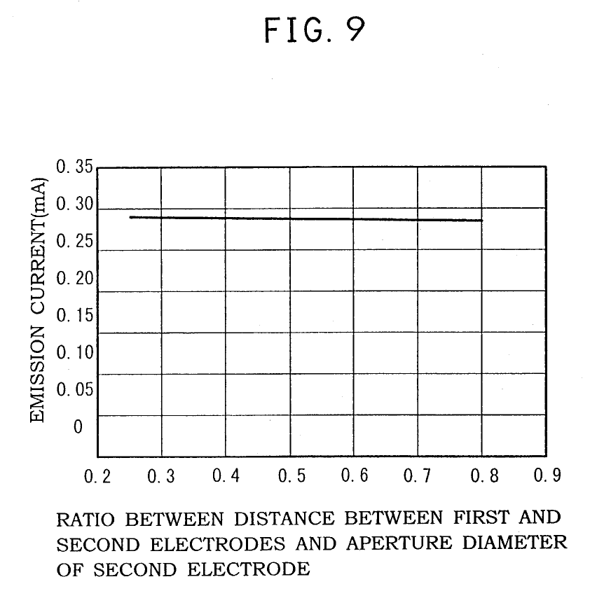

FIG. 8 illustrates the result of another simulation of Embodiment 3 using the distance between the first and second electrodes and the aperture diameter of the second electrode as parameters when the cutoff voltage is 65 V, the voltage at the first electrode is 0 V, and the voltage at the second electrode is 400 V. As apparent from FIG. 8, the distance between the first and second electrodes/the aperture diameter of the second electrode has to be not more than 0.73 for holding the emittance not more than 690 μm.mrad. FIG. 9 illustrates the emission current at 32 V of the cathode modulating voltage using the distance between the first and second electrodes/the aperture diameter of the second electrode as parameters. As apparent from FIG. 9, the emission current will rarely change when the distance between the first and second electrodes/the aperture diameter of the second electrode is changed

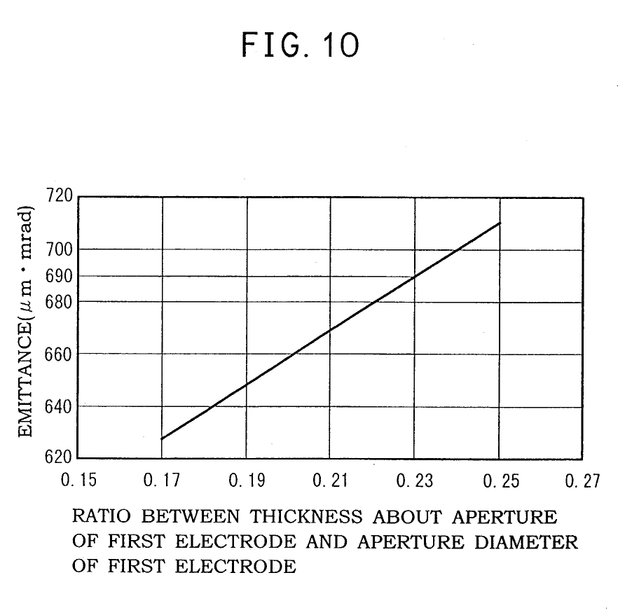

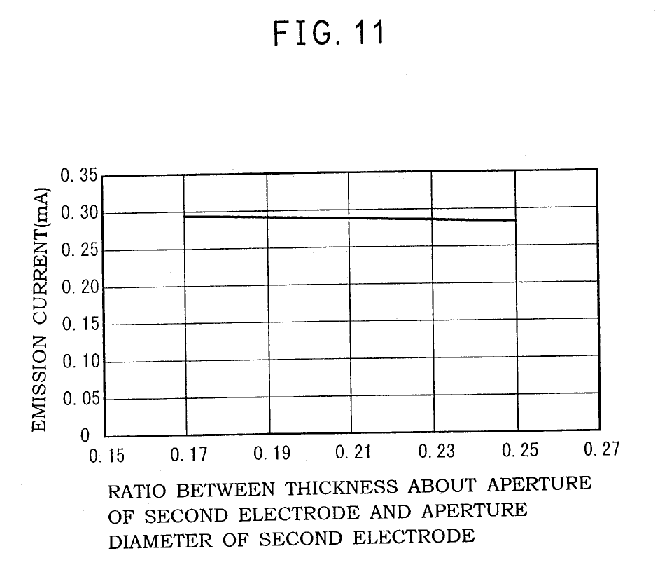

FIG. 10 illustrates the result of a further simulation of Embodiment 3 using the thickness about the aperture of the first electrode and the aperture diameter of the first electrode as parameters when the cutoff voltage is 65 V, the voltage at the first electrode is 0 V, and the voltage at the second electrode is 400 V. As apparent from FIG. 10, the thickness about the aperture of the first electrode/the aperture diameter of the first electrode has to be not more than 0.23 for holding the emittance not more than 690 μm.mrad. FIG. 11 illustrates the emission current at 32 V of the cathode modulating voltage using the thickness about the aperture of the first electrode/the aperture diameter of the first electrode as parameters. As apparent from FIG. 11, the emission current will rarely change when the thickness about the aperture of the first electrode/the aperture diameter of the first electrode is changed.

As explained, it is essential for decreasing the cutoff voltage to 65 V (practically from 50 V to 80 V), increasing the emission current, and maintaining the resolution at a level higher than that of the prior art to fulfill the four requirements defined in claim 2.

While the four requirements defined in claim 2 are favorably satisfied by the feature of Embodiment 3, they have to be fulfilled when the dimensions of the electron emission section of the electron gun are modified within a practical range.

### Embodiment 4

An arrangement of a cathode ray tube of Embodiment 4 is substantially identical to that shown in FIG. 12 except for the shape of the aperture of the first electrode. While the electron passing aperture of the first electrode of Embodiment 1 has a perfectly round shape, the same of Embodiment 4 is vertically ellipsoidal having 0.33 mm of a short diameter and 0.37 mm of a long diameter. Embodiment 4 is defined in claim 2.

Since the aperture of the first electrode is not round, the beam of electrons can be emitted in an asymmetrical cross section along the axis thus contributing to the improvement of the focusing characteristics throughout the screen. This method is frequently used in the electron gun technology and can hence be applied to the cathode ray tube of Embodiment 4. With the aperture arranged of a not-round shape, the focusing characteristics and the emission current might be equal to those with the round shape of substantially the same area. Since the area of the ellipsoidal shape of the aperture in the first electrode is equal to that of a round shape of 0.35 mm in diameter, its effect can be identical to that of Embodiment 3.

Although the aperture of the first electrode for passing electrons is arranged of an ellipsoidal shape in Embodiment 4, it might have any appropriate shape such as a rectangular or a combination of a rectangular and an oval.

### Embodiment 5

A fundamental arrangement of a cathode ray tube of Embodiment 5 is substantially identical to that shown in FIG. 12.

The electron emission section of the cathode ray tube like that shown in FIG. 12 is so arranged that the cathode voltage is 65 V at the cutoff action (based on the first electrode), the aperture diameters of the first and second electrodes are φ0.3 mm and φ0.40 mm respectively, the thicknesses of the first and second electrodes are 0.065 mm and 0.23 mm respectively, the distance between the first and second electrodes is 0.16 mm, and the voltages applied to the first and second electrodes are 0V and 400 V respectively.

In Embodiment 5, the aperture diameter of the first electrode, the thickness about the aperture of the first electrode, the aperture diameter of the second electrode, the thickness about the aperture of the second electrode, and the distance between the first and second electrodes are determined so as to satisfy:

the thickness about the aperture of the second electrode/the aperture diameter of the second electrode(≅0.58)≦0.87,

the distance between the first and second electrodes/the aperture diameter of the second electrode(≅0.40)≦0.69,

the thickness about the aperture of the first electrode/the aperture diameter of the first electrode(≅0.22)≦0.23, and

the aperture diameter of the second electrode=0.4 mm. Embodiment 5 is defined in claim 2

Since the construction of this embodiment satisfies the four requirements defined in claim 2, the emission current can be increased up to a level of approximately 1.7 times greater with the cathode modulating current remaining unchanged. Further, since Embodiment 5 generously fulfills three of the requirements, its emittance can be as smaller as 620 μm.mrad than that of the prior art hence offering an improved effect.

There is a problem, as compared with Embodiment 3, that discharge is easily occurred because of smaller distance of first and second electrode and deformation is easily generated during the assembling action because the thickness about the aperture of the first electrode is thin. Although three of the requirements defined in claim 2 are much desired to be fulfilled with a large margin, they might have lower limits due to the manufacturing factors. The lower limits are however unrelated to the feature of the present invention.

### Embodiment 6

An arrangement of a cathode ray tube of Embodiment 6 is substantially identical to that shown in FIG. 12. Embodiment 6 is defined in claim 2.

The electron emission section of the cathode ray tube of Embodiment 6 such as shown in FIG. 12 is so arranged that the cathode voltage is 65 V at the cutoff action (based on the first electrode), the aperture diameters of the first and second electrodes are Φ0.25 mm and Φ0.4 mm respectively, the thicknesses of the first and second electrodes are 0.05 mm and 0.18 mm respectively, the distance between the first and second electrodes is 0.12 mm, and the voltages applied to the first and second electrodes are 0V and 400 V respectively.

In Embodiment 6, the aperture diameter of the first electrode, the thickness about the aperture of the first electrode, the aperture diameter of the second electrode, the thickness about the aperture of the second electrode, and the distance between the first and second electrodes are determined so as to satisfy:

the thickness about the aperture of the second electrode/the aperture diameter of the second electrode(≅0.45)≦0.87,

the distance between the first and second electrodes/the aperture diameter of the second electrode(≅0.40)≦0.69,

the thickness about the aperture of the first electrode/the aperture diameter of the first electrode(≅0.20)≦0.23, and the aperture diameter of the second electrode=0.4 mm.

Accordingly, the emission current can be increased up to a level of approximately 1.7 times greater with the cathode modulating current remaining unchanged. Embodiment 6 generously fulfills the four requirements with a greater margin than that of Embodiment 1 or 2. As a result, the emittance can be as smaller as 570 μm.mrad and its effect will be enhanced.

When the four requirements defined in claim 2 are fulfilled with a generous margin, the emittance can be improved. However, the emittance has its lower limit due to the manufacturing factors. It is noted that the lower limit is unrelated to the feature of the present invention.

### Industrial Applicability

The present invention allows a cathode ray tube to be improved in the luminance while maintaining the resolution at a level equal to that of the prior art and thus utilized favorably for various kinds of CRT such as a CRT graphic display.

1. A cathode ray tub comprising a cathode and a first and a second electrodes provided with an electron passing aperture, the first and the second electrodes being disposed in front of and coaxially with the cathode so that electron beam from the cathode passes through the electron passing aperture, wherein the cathode voltage at the cutoff operation is set up from 50 V to 80 V on the basis of the first electrode.

2. The cathode ray tube of claim 1, wherein the aperture diameter of the first electrode, the thickness about the aperture of the first electrode, the aperture diameter of the second electrode, the thickness about the aperture of the second electrode, and the distance between the first and second electrodes satisfy the following conditional equation:
the thickness about the aperture of the second electrode/the aperture diameter of the second electrode≦0.87;
the distance between the first and second electrodes/the aperture diameter of the second electrode≦0.73;
the thickness about the aperture of the first electrode/the aperture diameter of the first electrode≦0.23; and
the aperture diameter of the second electrode≧0.4 mm.

3. The cathode ray tube of claim 1, wherein the cathode comprises a tungsten layer formed on a substrate surface, and an alkaline earth metal oxide containing at least Ba and an alkaline earth metal deposited on the tungsten layer.
